(19) United States
(12) Patent Application Publication
(10) Pub. No.: US 2024/0404256 A1
(43) Pub. Date: Dec. 5, 2024

(54) END-TO-END TRAINABLE ADVANCED DRIVER-ASSISTANCE SYSTEMS

(71) Applicant: Waymo LLC, Mountain View, CA (US)

(72) Inventors: Vasiliy Igorevich Karasev, San Francisco, CA (US); Thomas Deegan, San Francisco, CA (US); James W. Philbin, Palo Alto, CA (US)

(21) Appl. No.: 18/679,182

(22) Filed: May 30, 2024

Related U.S. Application Data
(60) Provisional application No. 63/505,352, filed on May 31, 2023.

(51) Int. Cl. G06V 10/774; G06V 10/764; G06V 20/58

(52) U.S. Cl. CPC G06V 10/774; G06V 10/764; G06V 20/58

(57) ABSTRACT

The disclosed systems and techniques are directed to computationally efficient detection and tracking of objects in driving environments. The techniques include generating a set of auto-labeled training data using a first autonomous vehicle (AV) system having multiple sensor modalities. The auto-labeled training data includes a first set of non-lidar data associated with the first AV system, and one or more target predictions for the first set of non-lidar data, said predictions generated based at least on lidar data associated with the first AV system. The techniques further include training, by the processing device and using the auto-labeled training data, an end-to-end perception model of a second AV system lacking a lidar sensor to predict presence of one or more objects in a driving environment of the second AV system.

### RELATED APPLICATIONS

This application claims the benefit of the U.S. Provisional Patent Application No. 63/505,352, filed May 31, 2023, entitled “END-TO-END TRAINABLE ADVANCED DRIVER-ASSISTANCE SYSTEMS,” the contents of which are incorporated by reference in their entirety herein.

### TECHNICAL FIELD

The instant specification generally relates to systems and applications that detect and classify objects and, in particular, to autonomous vehicles and vehicles deploying advanced driver-assistance system (ADAS) technology. More specifically, the instant specification relates to end-to-end trainable ADAS for faster and more resource-efficient detection and tracking of objects, including but not limited to vehicles, pedestrians, bicyclists, animals, and the like.

### BACKGROUND

An autonomous (fully or partially self-driving) vehicle (AV) operates by sensing an outside environment with various electromagnetic (e.g., radar and optical) and non-electromagnetic (e.g., audio and humidity) sensors. Some autonomous vehicles chart a driving path through the environment based on the sensed data. The driving path can be determined based on Global Navigation Satellite System (GNSS) data and road map data. While the GNSS and the road map data can provide information about static aspects of the environment (buildings, street layouts, road closures, etc.), dynamic information (such as information about other vehicles, pedestrians, streetlights, etc.) is obtained from contemporaneously collected sensing data. Precision and safety of the driving path and of the speed regime selected by the autonomous vehicle depend on timely and accurate identification of various objects present in the driving environment and on the ability of a driving algorithm to process the information about the environment and to provide correct instructions to the vehicle controls and the drivetrain.

### BRIEF DESCRIPTION OF THE DRAWINGS

The present disclosure is illustrated by way of examples, and not by way of limitation, and can be more fully understood with references to the following detailed description when considered in connection with the figures, in which:

FIG. 1 is a diagram illustrating components of an example autonomous vehicle (AV), in accordance with some implementations of the present disclosure.

FIGS. 2A-2B are diagrams illustrating example architectures of a part of a perception system that is capable of efficient detection and classification of objects, in accordance with some implementations of the present disclosure.

FIGS. 3A-3B are diagrams illustrating example systems that can be used to implement end-to-end (E2E) trainable advanced driver-assistance systems, in accordance with some implementations of the present disclosure. FIG. 3C illustrates example operations that can be used for training E2E advanced driver-assistance systems, in accordance with some implementations of the present disclosure.

FIGS. 4A-4B illustrate example methods of implementing end-to-end (E2E) trainable advanced driver-assistance systems, in accordance with some implementations of the present disclosure.

FIG. 5 depicts a block diagram of an example computing device capable of implementing camera-radar data fusion to generate a fused bird's-eye view (BEV) grid for efficient object detection, in accordance with some implementations of the present disclosure.

### SUMMARY

In one implementation, disclosed is a method that includes generating a set of auto-labeled training data using a first autonomous vehicle (AV) system having multiple sensor modalities. The auto-labeled training data includes a first set of non-lidar data associated with the first AV system, and one or more target predictions for the first set of non-lidar data, said predictions generated based at least on lidar data associated with the first AV system. The method further includes training, by the processing device and using the auto-labeled training data, an end-to-end perception model of a second AV system lacking a lidar sensor to predict presence of one or more objects in a driving environment of the second AV system.

In another implementation, disclosed is a system that includes a memory and a processing device, operatively coupled to the memory. The processing device is configured to generate a set of auto-labeled training data using a first AV system having multiple sensor modalities. The auto-labeled training data includes a first set of non-lidar data associated with the first AV system, and one or more target predictions for the first set of non-lidar data, said predictions generated based at least on lidar data associated with the first AV system. The processing device is further configured to train, using the auto-labeled training data, an end-to-end perception model of a second AV system lacking a lidar sensor to predict presence of one or more objects in a driving environment of the second AV system.

In yet another implementation, disclosed is a non-transitory computer-readable storage medium having instructions stored thereon that, when executed by a processing device, cause the processing device to perform operations that include generating a set of auto-labeled training data using a first AV system having multiple sensor modalities. The auto-labeled training data includes a first set of non-lidar data associated with the first AV system, and one or more target predictions for the first set of non-lidar data, said predictions generated based at least on lidar data associated with the first AV system. The operations further include training, using the auto-labeled training data, an end-to-end perception model of a second AV system lacking a lidar sensor to predict presence of one or more objects in a driving environment of the second AV system.

### DETAILED DESCRIPTION

Although various implementations can be described below, for the sake of illustration, using autonomous driving systems and driver assistance systems as examples, it should be understood that the techniques and systems described herein can be used for tracking of objects in a wide range of applications, including aeronautics, marine applications, traffic control, animal control, industrial and academic research, public and personal safety, or in any other application where automated detection of objects is advantageous.

An autonomous vehicle or a vehicle deploying various advanced driver-assistance features can use multiple sensor types (modalities) to facilitate detection of objects in outside environments and predict future trajectories of such objects. Sensors can include radio detection and ranging (radar) sensors, light detection and ranging (lidar) sensors, digital cameras, ultrasonic sensors, positional sensors, and the like. Different types of sensors can provide different and complementary benefits. For example, radars and lidars emit electromagnetic signals (radio signals or optical signals) that reflect from the objects and carry back information about distances to the objects (e.g., determined from time of flight of the signals) and velocities of the objects (e.g., from the Doppler shift of the frequencies of the reflected signals). Radars and lidars can scan an entire 360-degree view by using a series of consecutive sensing frames. Sensing frames can include numerous reflections covering the outside environment in a dense grid of return points. Each return point can be associated with the distance to the corresponding reflecting object and a radial velocity (a component of the velocity along the line of sight) of the reflecting object.

Collected sensor data has to be timely, efficiently, and accurately processed by an onboard perception system to create a representation of the outside environment, which may include locations, velocities, and motion histories (tracks) of various objects in the outside environment. Accurate and reliable outputs of the perception system enable a vehicle's planning system to chart a safe and efficient driving path that complies with directions of traffic lights, road signs, road layouts, etc., and avoids other vehicles and obstacles. Since perception and planning processing involves complex and sophisticated computations, the safety of autonomous driving operations depends on the speed and accuracy of techniques used for detection, classification, and tracking of various road users and other objects encountered on or near roadways, such as road obstacles, construction equipment, roadside structures, and the like.

Some systems and methods of object identification and tracking use various sensing modalities, such as lidars, radars, cameras, etc., to obtain images of the environment. The images can then be processed by trained machine learning models to identify locations of various objects in the images (e.g., in the form of bounding boxes), state of motion of the objects (e.g., speed, as detected by lidar or radar Doppler effect-based sensors), object types (e.g., a vehicle or pedestrian), and so on. Motion of objects (or any other evolution, such as splitting of a single object into multiple objects) can be performed by creating and maintaining tracks associated with a particular object.

Using multiple sensing modalities (e.g., lidars, radars, cameras) to obtain often complementary data improves precision of object detection, identification, and tracking but comes at a substantial cost in sensing hardware and processing software. For example, a lidar sensor can provide valuable information about distances to various reflecting surfaces in the outside environment. A lidar sensor, however, is an expensive optical and electronic device that operates by actively probing the outside environment with optical signals and requires considerable maintenance and periodic calibration. Lidar returns (the point cloud) have to be processed, segmented into groups associated with separate hypothesized objects, and matched with objects detected using other sensing modalities (e.g., cameras), which requires additional processing and memory resources. Cameras, on the other hand, operate by passively collecting light (and/or infrared electromagnetic waves) emitted (or reflected) by objects of the environment and are significantly simpler and cheaper in design, installation, and operations. Consequently, various driver assistance systems that do not deploy lidars (for costs and maintenance reasons) are typically equipped with one or more cameras. Cameras can also be more easily installed at various stationary locations and used for traffic monitoring and control, public and private safety applications, and the like. Being based on optical or infrared imaging technology, cameras have certain advantages over radars, which, while allowing detection of distances to (and velocities of) objects, operate in a range of wavelengths that has intrinsically lower resolution compared with cameras. An ability to detect and identify objects based on camera-only images is, therefore, beneficial.

Cameras, however, produce projections of a three-dimensional (3D) outside environment onto a two-dimensional imaging surface (e.g., an array of camera's light detectors), which may be a plane or a curved surface. This gives rise to some related challenges. On one hand, distances to objects (often referred to depths of the objects in the image) are not immediately known (though can often be determined from the context of the imaged objects). On the other hand, camera images have perspective distortions causing the same number of pixels separating images of objects to correspond to different distances between objects depending on the depths of the objects. Additionally, objects whose depictions are proximate to each other can nonetheless be separated by a significant distance (e.g., a car and a pedestrian visible behind the car).

Effectiveness of onboard perception systems that use camera images can be significantly increased by inclusion of data of sensing modalities that directly detect ranges of (distances to) various objects, such as lidar sensors or radar sensors. Lidar sensors-often deployed on L4 systems—have a high spatial resolution but are expensive. L2 and L3 systems, on the other hand, usually deploy radar sensors, which are cheaper to manufacture and maintain, but provide similar lidar ranging capabilities. Lower resolution of radar sensors, however, can be leveraged in combination with camera sensors, with camera sensors ensuring high lateral resolution and radar sensors contributing the ranging function.

Camera images and radar data, however, are usually acquired in different frames of reference (e.g., the perspective view for camera images and spherical or cylindrical system of coordinates for radar data). As disclosed herein, efficient processing of combined camera and radar data (and lidar data, in L4 systems) can be achieved by using the top-down view, also known as the bird's-eye view (BEV), in which objects are represented on a convenient manifold, e.g., a plane viewed from above and characterized by a simple set of Cartesian coordinates. Object identification and tracking can subsequently be performed directly within the BEV representation. Success of such techniques depends on accurate mapping of the objects to the BEV representation. This, in turn, can rely on precise estimates of distances to various objects since misplacing of the objects within the BEV representation can result not only in an error in ascertaining a distance to a road user but may also lead to a loss of important contextual information.

The input data can be used to generate a fused BEV grid formed by fusing together a plurality of BEV grids. More particularly, at least two of the BEV grids can have a different scale (e.g., resolution and/or size). For example, a first BEV grid can have a first scale and a second BEV grid can have a second scale different from the first scale. Each BEV grid can be generated by transforming a respective set of features extracted from the input data into a respective set of points, and voxelizing the sets of points to generate the plurality of BEV grids. Accordingly, a BEV grid can also be referred to as a BEV voxel grid.

For example, a set of camera data features can be extracted from the camera data, and the set of camera data features can be transformed into a set of pixel points. Transforming the set of camera data features into the set of pixel points can include projecting three-dimensional (3D) camera data onto a two-dimensional (2D) space. As another example, a set of radar data features can be extracted from the radar data, and the set of radar data features can be transformed into a set of radar points. Transforming the set of radar data features into the set of radar points can include transforming a coordinate representation of the radar data. For example, if the radar data has a polar coordinate representation, the coordinate representation of the radar data can be transformed into a Cartesian coordinate representation.

Camera images, radar data, and/or lidar data (if applicable) can depict a very large number of different objects in a variety of settings, surrounding, traffic conditions, and so on. Because of this diversity sensing data, rule-based perception processing is usually less effective than artificial intelligence techniques, such as computer vision machine learning models. In L4 systems, which can be equipped with large computational (e.g., processing and memory) resources, multiple machine learning models can be deployed for performing different subtasks of larger tasks, processing different sensing modalities, identification of different types of objects, various types of situations that can be encountered in driving environments, and so on. In L2/L3 systems, having lower computational resources, fewer models can be simultaneously deployed for processing of data. As a result, L2/L3 systems benefit from use of efficient and compact end-to-end models trained to perform detection and classification tasks starting from raw input sensing data to final classifications without intermediate steps or feature engineering.

Disclosed herein is an end-to-end perception model (EEPM), which can include a neural network architecture, can be trained to make predictions related to AV perception. Depending on computational complexity and sophistication of training, EEPM can be used in various levels of driving automation, including Level 2 driving assistance systems (L2 systems), Level 3 contextual autonomous driving systems (L3 systems), Level 4 predominantly autonomous driving systems (L4 systems), Level 5 fully autonomous driving systems (L5 systems), etc. For example, an EEPM can be trained using sensor dropout scenarios, in which some of the sensors are removed or non-operational (e.g., at least one camera and/or at least one radar). For example, a right-side facing camera can be removed and the information about the objects in the portion of space covered by the right-side facing camera can be provided by other sensing modalities (e.g., lidar and/or radar sensors). In some embodiments, training scenarios can also include a complete removal (dropout) of a particular sensing modality, e.g., removal of lidar data feed, such that all information about the environment is provided by cameras and radars. Accordingly, an EEPM can be trained to generate predictions that are robust against failure of individual sensors and entire sensing modalities. That is, the disclosed techniques include training a perception model to generate predictions without some of the sensor data typically present in a perception system. The disclosed techniques enable leveraging a perception system of an LA system to train a perception system (e.g., for use in L2 or L3 platforms) that uses the camera modality and/or radar modality but does not use the lidar modality, advantageously resulting in a much simpler perception system with advanced capabilities yet fewer software subcomponents. Such a simpler, yet robust, perception system can be used in an ADAS for faster and more resource-efficient detection and tracking of objects.

Another challenge of current machine learning development is the need and expense of manual annotation or labels (e.g., human-generated labeling) of training data. For example, machine learning models that implement large neural networks that are trained for end-to-end learning applications, such as EEPMs, can require large amounts of supervision to achieve good quality.

Aspects and implementations of the present disclosure address these and other challenges of the existing automotive technology by enabling methods and systems that can implement end-to-end trainable driver-assistance systems using EEPMs. In particular, the disclosed techniques can be used to generate training data for training an EEPM, and train the EEPM to generate a prediction using input data from a set of sensors of an AV. More specifically, the EEPM can be used to determine how an AV should perceive a driving environment and how the AV should react to the driving environment. For example, an EEPM can include a neural network architecture including a set of neural networks.

The training data can include data annotated with labels that are automatically generated based on sensor data obtained from a data collection sensor suite including a combination of sensor modalities. The data collection sensor suite can include a more sophisticated or advanced set of sensors that can be designated to generate sufficiently high quality sensor data. For example, the data collection sensor suite can include a camera(s), radar(s) and lidar(s). In some embodiments, the data collection sensor suite includes at least an LA system. For example, multiple data collection AVs (e.g., a fleet of data collection AVs) each have the data collection sensor suite installed thereon.

Instead of using the sensor data obtained from the data collection sensor suite (e.g., raw sensor data) to directly generate labels, the sensor data obtained from the data collection sensor suite can be input into a perception system to generate a set of auto-labeling input data. The set of auto-labeling input data can be used to automatically generate labels to include in the training data that can be used to train an EEPM that can be used to determine how an AV should perceive a driving environment and how the AV should react to the driving environment. Additionally, the data collection sensor suite can include a computing device with multiple graphics processing units (GPUs) for computational power.

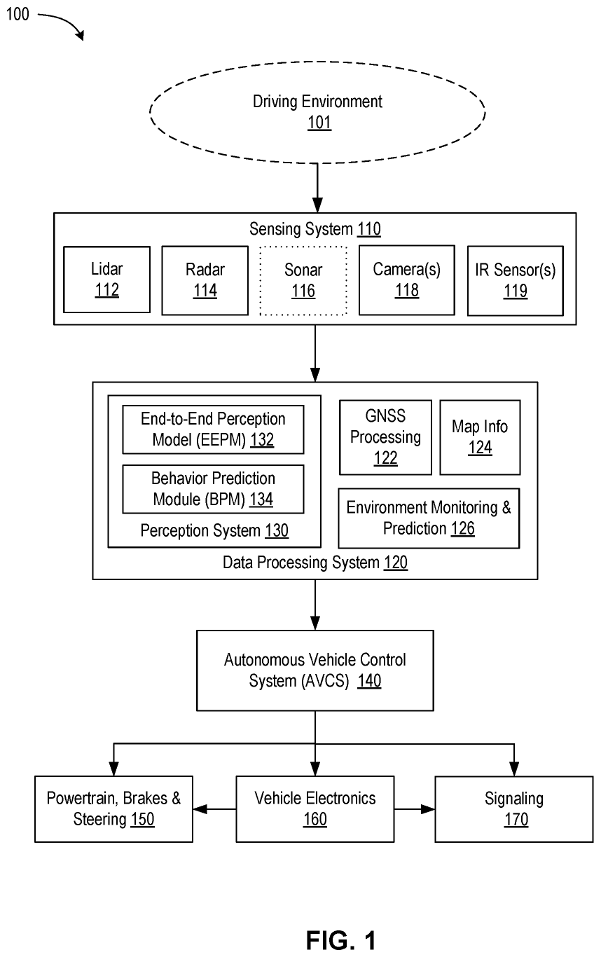

The training data can be used to train an EEPM that can be utilized by a perception system designed to work with sensor data obtained from a less sophisticated (“base”) AV sensor suite. For example, the base AV sensor suite can include camera(s) and radar(s). In some embodiments, the base AV sensor suite includes an L2 sensor system. Thus, accordingly, training data for training a less sophisticated EEPM model can be generated from labels that are automatically generated based on higher quality/fidelity sensor data. Training the EEPM by leveraging sensor data obtained from a more sophisticated or advanced data collection sensor suite, as described herein, can improve computational efficiency and reduce computational cost. Further details regarding implementing (E2E) trainable driver-assistance systems will be described below with reference to FIGS. 1-5.

Advantages of the described implementations include (but are not limited to) fast and accurate detection, identification, and tracking of objects in a way that avoids large computational overheads of processing of data of multiple sensing modalities. Since the machine learning models trained and deployed as disclosed herein are capable of efficient object detection based on input data (e.g., camera data and radar data), EEPMs described herein can be deployed on a variety of platforms (e.g., AVs) including systems with modest computational resources.

FIG. 1 is a diagram illustrating components of an example autonomous vehicle (AV) 100, in accordance with some implementations of the present disclosure. Autonomous vehicles can include motor vehicles (cars, trucks, buses, motorcycles, all-terrain vehicles, recreational vehicles, any specialized farming or construction vehicles, and the like), aircraft (planes, helicopters, drones, and the like), naval vehicles (ships, boats, yachts, submarines, and the like), spacecraft (controllable objects operating outside Earth atmosphere) or any other self-propelled vehicles (e.g., robots, factory or warehouse robotic vehicles, sidewalk delivery robotic vehicles, etc.) capable of being operated in a self-driving mode (without a human input or with a reduced human input).

Vehicles, such as those described herein, may be configured to operate in one or more different driving modes. For instance, in a manual driving mode, a driver may directly control acceleration, deceleration, and steering via inputs such as an accelerator pedal, a brake pedal, a steering wheel, etc. A vehicle may also operate in one or more autonomous driving modes including, for example, a semi-autonomous or partially autonomous driving mode in which a person exercises some amount of direct or remote control over driving operations, or a fully autonomous driving mode in which the vehicle handles the driving operations without direct or remote control by a person. These vehicles may be known by different names including, for example, autonomously driven vehicles, self-driving vehicles, and so on.

As described herein, in a semi-autonomous or partially autonomous driving mode, even though the vehicle assists with one or more driving operations (e.g., steering, braking and/or accelerating to perform lane centering, adaptive cruise control, advanced driver assistance systems (ADAS), or emergency braking), the human driver is expected to be situationally aware of the vehicle's surroundings and supervise the assisted driving operations. Here, even though the vehicle may perform all driving tasks in certain situations, the human driver is expected to be responsible for taking control as needed.

Although, for brevity and conciseness, various systems and methods may be described below in conjunction with autonomous vehicles, similar techniques can be used in various driver assistance systems that do not rise to the level of fully autonomous driving systems. In the United States, the Society of Automotive Engineers (SAE) have defined different levels of automated driving operations to indicate how much, or how little, a vehicle controls the driving, although different organizations, in the United States or in other countries, may categorize the levels differently. More specifically, disclosed systems and methods can be used in SAE Level 2 driver assistance systems that implement steering, braking, acceleration, lane centering, adaptive cruise control, etc., as well as other driver support. The disclosed systems and methods can be used in SAE Level 3 driving assistance systems capable of autonomous driving under limited (e.g., highway) conditions. Likewise, the disclosed systems and methods can be used in vehicles that use SAE Level 4 self-driving systems that operate autonomously under most regular driving situations and require only occasional attention of the human operator. In all such driving assistance systems, accurate lane estimation can be performed automatically without a driver input or control (e.g., while the vehicle is in motion) and result in improved reliability of vehicle positioning and navigation and the overall safety of autonomous, semi-autonomous, and other driver assistance systems. As previously noted, in addition to the way in which SAE categorizes levels of automated driving operations, other organizations, in the United States or in other countries, may categorize levels of automated driving operations differently. Without limitation, the disclosed systems and methods herein can be used in driving assistance systems defined by these other organizations' levels of automated driving operations.

A driving environment 101 can include any objects (animate or inanimate) located outside the AV, such as roadways, buildings, trees, bushes, sidewalks, bridges, mountains, other vehicles, pedestrians, piers, banks, landing strips, animals, birds, and so on. The driving environment 101 can be urban, suburban, rural, and so on. In some implementations, the driving environment 101 can be an off-road environment (e.g., farming or other agricultural land). In some implementations, the driving environment 101 can be an indoor environment, e.g., the environment of an industrial plant, a shipping warehouse, a hazardous area of a building, and so on. In some implementations, the driving environment 101 can be substantially flat, with various objects moving parallel to a surface (e.g., parallel to the surface of Earth). In other implementations, the driving environment 101 can be three-dimensional and can include objects that are capable of moving along all three directions (e.g., balloons, falling leaves, etc.). Hereinafter, the term “driving environment” should be understood to include all environments in which an autonomous motion (e.g., SAE Level 5 and SAE Level 4 systems), conditional autonomous motion (e.g., SAE Level 3 systems), and/or motion of vehicles equipped with driver assistance technology (e.g., SAE Level 2 systems) can occur. Additionally, “driving environment” can include any possible flying environment of an aircraft (or spacecraft) or a marine environment of a naval vessel. The objects of the driving environment 101 can be located at any distance from the AV, from close distances of several feet (or less) to several miles (or more).

The example AV 100 can include a sensing system 110. The sensing system 110 can include various electromagnetic (e.g., optical, infrared, radio wave, etc.) and non-electromagnetic (e.g., acoustic) sensing subsystems and/or devices. The sensing system 110 can include one or more lidars 112, which can be a laser-based unit capable of determining distances to the objects and velocities of the objects in the driving environment 101. The sensing system 110 can include one or more radars 114, which can be any system that utilizes radio or microwave frequency signals to sense objects within the driving environment 101 of the AV 100. The lidar(s) 112 and or radar(s) 114 can be configured to sense both the spatial locations of the objects (including their spatial dimensions) and velocities of the objects (e.g., using the Doppler shift technology). Hereinafter, “velocity” refers to both how fast the object is moving (the speed of the object) as well as the direction of the object's motion. Each of the lidar(s) 112 and radar(s) 114 can include a coherent sensor, such as a frequency-modulated continuous-wave (FMCW) lidar or radar sensor. For example, lidar(s) 112 and/or radar(s) 114 can use heterodyne detection for velocity determination. In some implementations, the functionality of a time-of-flight (ToF) sensor and coherent lidar (or radar) is combined into a lidar (or radar) unit capable of simultaneously determining both the distance to and the radial velocity of the reflecting object. Such a unit can be configured to operate in an incoherent sensing mode (ToF mode) and/or a coherent sensing mode (e.g., a mode that uses heterodyne detection) or both modes at the same time. In some implementations, multiple lidars 112 and/or radar 114s can be mounted on AV 100.

Lidar 112 (and/or radar 114) can include one or more optical sources (and/or radio/microwave sources) producing and emitting signals and one or more detectors of the signals reflected back from the objects. In some implementations, lidar 112 and/or radar 114 can perform a 360-degree scanning in a horizontal direction. In some implementations, lidar 112 and/or radar 114 can be capable of spatial scanning along both the horizontal and vertical directions. In some implementations, the field of view can be up to 60 degrees in the vertical direction (e.g., with at least a part of the region above the horizon being scanned with lidar or radar signals). In some implementations (e.g., aerospace applications), the field of view can be a full sphere (consisting of two hemispheres).

The sensing system 110 can further include one or more cameras 118 to capture images of the driving environment 101. Cameras 118 can operate in the visible part of the electromagnetic spectrum, e.g., 300-800 nm range of wavelengths (herein also referred for brevity as the optical range). Some of the optical range cameras 118 can use a global shutter while other cameras 118 can use a rolling shutter. The images can be two-dimensional projections of the driving environment 101 (or parts of the driving environment 101) onto a projecting surface (flat or non-flat) of the camera(s). Some of the cameras 118 of the sensing system 110 can be video cameras configured to capture a continuous (or quasi-continuous) stream of images of the driving environment 101. The sensing system 110 can also include one or more sonars 116, for active sound probing of the driving environment 101, e.g., ultrasonic sonars, and one or more microphones for passive listening to the sounds of the driving environment 101. The sensing system 110 can also include one or more infrared range (IR) sensors 119. For example, IR sensor(s) 119 can include an IR camera. IR sensor(s) 119 can use focusing optics (e.g., made of germanium-based materials, silicon-based materials, etc.) that is configured to operate in the range of wavelengths from microns to tens of microns or beyond. IR sensor(s) 119 can include a phased array of IR detector elements. Pixels of IR images produced by IR sensor(s) 119 can be representative of the total amount of IR radiation collected by a respective detector element (associated with the pixel), of the temperature of a physical object whose IR radiation is being collected by the respective detector element, or any other suitable physical quantity.

The sensing data obtained by the sensing system 110 can be processed by a data processing system 120 of AV 100. For example, the data processing system 120 can include a perception system 130. The perception system 130 can be configured to detect and track objects in the driving environment 101 and to recognize the detected objects. For example, the perception system 130 can analyze images captured by the cameras 118 and can be capable of detecting traffic light signals, road signs, roadway layouts (e.g., boundaries of traffic lanes, topologies of intersections, designations of parking places, and so on), presence of obstacles, and the like. The perception system 130 can further receive radar sensing data (Doppler data and ToF data) to determine distances to various objects in the environment 101 and velocities (radial and, in some implementations, transverse, as described below) of such objects. In some implementations, the perception system 130 can use radar data in combination with the data captured by the camera(s) 118, as described in more detail below.

The perception system 130 can include one or more components to facilitate detection, classification, and tracking of objects, including an end-to-end perception model (EEPM) 132 that can be used to process data provided by the sensing system 110. More specifically, in some implementations, EEPM 132 can receive data from sensors of different sensing modalities. For example, EEPM 132 can receive images from at least some of lidar(s) 112, radar(s) 114, and (optical range) camera(s) 118, IR sensor(s) 119, sonar(s) 116 and the like. In particular, EEPM 132 can include one or more trained machine-learning models (MLMs) that are used to process some or all of the above data to detect, classify, and track motion of various objects in the driving environment 101. EEPM 132 can use multiple classifier heads to determine various properties of the outside environment, including but not limited to occupation of space with various objects, types of the objects, motion of the objects, identification of objects that can be occluded, relation of the objects to the roadway, to other objects, and to the traffic flow. Various models of EEPM 132 can be trained using multiple sets of images/data, annotated to identify specific features in the respective sensing data. In some implementations, the perception system 130 can include a behavior prediction module (BPM) 134 that predicts future motion of the detected objects.

The perception system 130 can further receive information from a Global Navigation Satellite System (GNSS) positioning subsystem (not shown in FIG. 1), which can include a GNNS transceiver (not shown), configured to obtain information about the position of the AV relative to Earth and its surroundings. The positioning subsystem can use the positioning data, e.g., GNNS and inertial measurement unit (IMU) data in conjunction with the sensing data to help accurately determine the location of the AV with respect to fixed objects of the driving environment 101 (e.g., roadways, lane boundaries, intersections, sidewalks, crosswalks, road signs, curbs, surrounding buildings, etc.) whose locations can be provided by map information 124. In some implementations, the data processing system 120 can receive non-electromagnetic data, such as audio data (e.g., ultrasonic sensor data from sonar 116 or data from microphone picking up emergency vehicle sirens), temperature sensor data, humidity sensor data, pressure sensor data, meteorological data (e.g., wind speed and direction, precipitation data), and the like.

The data processing system 120 can further include an environment monitoring and prediction component 126, which can monitor how the driving environment 101 evolves with time, e.g., by keeping track of the locations and velocities of the animated objects (e.g., relative to Earth). In some implementations, the environment monitoring and prediction component 126 can keep track of the changing appearance of the environment due to a motion of the AV relative to the environment. In some implementations, the environment monitoring and prediction component 126 can make predictions about how various animated objects of the driving environment 101 will be positioned within a prediction time horizon. The predictions can be based on the current state of the animated objects, including current locations (coordinates) and velocities of the animated objects. Additionally, the predictions can be based on a history of motion (tracked dynamics) of the animated objects during a certain period of time that precedes the current moment. For example, based on stored data for a first object indicating accelerated motion of the first object during the previous 3-second period of time, the environment monitoring and prediction component 126 can conclude that the first object is resuming its motion from a stop sign or a red traffic light signal. Accordingly, the environment monitoring and prediction component 126 can predict, given the layout of the roadway and presence of other vehicles, where the first object is likely to be within the next 3 or 5 seconds of motion. As another example, based on stored data for a second object indicating decelerated motion of the second object during the previous 2-second period of time, the environment monitoring and prediction component 126 can conclude that the second object is stopping at a stop sign or at a red traffic light signal. Accordingly, the environment monitoring and prediction component 126 can predict where the second object is likely to be within the next 1 or 3 seconds. The environment monitoring and prediction component 126 can perform periodic checks of the accuracy of its predictions and modify the predictions based on new data obtained from the sensing system 110. The environment monitoring and prediction component 126 can operate in conjunction with EEPM 132. For example, the environment monitoring and prediction component 126 can track relative motion of the AV and various objects (e.g., reference objects that are stationary or moving relative to Earth).

The data generated by the perception system 130, the GNSS processing module 122, and the environment monitoring and prediction component 126 can be used by an autonomous driving system, such as AV control system (AVCS) 140. The AVCS 140 can include one or more algorithms that control how AV is to behave in various driving situations and environments. For example, the AVCS 140 can include a navigation system for determining a global driving route to a destination point. The AVCS 140 can also include a driving path selection system for selecting a particular path through the driving environment 101, which can include selecting a traffic lane, negotiating a traffic congestion, choosing a place to make a U-turn, selecting a trajectory for a parking maneuver, and so on. The AVCS 140 can also include an obstacle avoidance system for safe avoidance of various obstructions (rocks, stalled vehicles, and so on) within the driving environment of the AV. The obstacle avoidance system can be configured to evaluate the size of the obstacles and the trajectories of the obstacles (if obstacles are animated) and select an optimal driving strategy (e.g., braking, steering, accelerating, etc.) for avoiding the obstacles.

Algorithms and modules of AVCS 140 can generate instructions for various systems and components of the vehicle, such as the powertrain, brakes, and steering 150, vehicle electronics 160, signaling 170, and other systems and components not explicitly shown in FIG. 1. The powertrain, brakes, and steering 150 can include an engine (internal combustion engine, electric engine, and so on), transmission, differentials, axles, wheels, steering mechanism, and other systems. The vehicle electronics 160 can include an on-board computer, engine management, ignition, communication systems, carputers, telematics, in-car entertainment systems, and other systems and components. The signaling 170 can include high and low headlights, stopping lights, turning and backing lights, horns and alarms, inside lighting system, dashboard notification system, passenger notification system, radio and wireless network transmission systems, and so on. Some of the instructions output by the AVCS 140 can be delivered directly to the powertrain, brakes, and steering 150 (or signaling 170) whereas other instructions output by the AVCS 140 are first delivered to the vehicle electronics 160, which generates commands to the powertrain, brakes, and steering 150 and/or signaling 170.

In one example, EEPM 132 can determine that images obtained by camera(s) 118 include depictions of an object and can further classify the object as a bicyclist. The environment monitoring and prediction component 126 can track the bicyclist and determine that the bicyclist is travelling with the speed of 15 mph along an intersecting road perpendicular to the direction of the motion of the vehicle. Responsive to such a determination, the BPM 134 can determine that the vehicle needs to slow down to let the bicyclist clear the intersection. The AVCS 140 can output instructions to the powertrain, brakes, and steering 150 (directly or via the vehicle electronics 160) to: (1) reduce, by modifying the throttle settings, a flow of fuel to the engine to decrease the engine rpm; (2) downshift, via an automatic transmission, the drivetrain into a lower gear; and (3) engage a brake unit to reduce (while acting in concert with the engine and the transmission) the vehicle's speed. After EEPM 132 and/or the environment monitoring and prediction component 126 determined that the bicyclist has crossed the intersection, the AVCS 140 can output instructions to the powertrain, brakes, and steering 150 to resume the previous speed settings of the vehicle.

The output of EEPM 132 can be used for tracking of detected objects. In some implementations, tracking can be reactive and can include history of poses (positions and orientations) and velocities of the tracked objects. In some implementations, tracking can be proactive and can include prediction of future poses and velocities of the tracked objects. In some implementations, future predictions can be generated by BPM 134, e.g., based at least partially on the output of EEPM 132. In some implementations, tracking-by-detection or instance segmentation can be used instead of building an explicit tracker. For example, an interface of BPM 134 can include, for each object, a history of recent object locations, extents, headings and velocities. In some implementations, flow information can be defined with reference to units of three-dimensional space (voxels). For additional accuracy of prediction, flow information associated with individual voxels can include not only velocities but also kinematic attributes, such as curvature, yaw rate, and the like. Based on this data, BPM 134 can predict future trajectories in a way that is advantageous over a more traditional tracking approach. In some implementations, an alternative approach can be used that deploys a recurrent neural network (RNN) to smooth and interpolate locations and velocities over time, which may be performed similarly to operations of a Kalman filter.

The output of EEPM 132 can be used for vehicle localization. In some implementations, BPM 134 can use lidar-based global mapping that maps an entire region of 3D environment around the vehicle. In some implementations, BPM 134 can deploy a simpler system that uses accelerometry, odometry, GNNS data, as well as camera-based lane mapping to identify the current position of the vehicle relative to the map data.

In different implementations, BPM 134 can have different levels of sophistication depending on the driving environment 101 (e.g., highway driving, urban driving, suburban driving, etc.). In L2 systems (“hands on the wheel”), where the driver is expected at any time to take over the vehicle's control, BPM 134 can have a minimum functionality and be able to predict behavior of other road users within a short time horizon, e.g., several seconds. For example, such predictions can include impeding lane changes by other vehicles (“agents”). BPM 134 can use various cues, such as a turning signal, front wheel turning, a driver turning the head in the direction of a turn, and the like. BPM 134 can determine if such impending lane changes require driver's attention. In the instances where a lane changing agent is sufficiently far from the vehicle, AVCS 140 acting on BPM 134 prediction can change the vehicle's trajectory (e.g., slow the vehicle down) without driver's involvement. In the instances where a change requires immediate driver's attention, BPM 134 can output a signal to the driver indicating that the driver should take over controls of the vehicle.

In L3 systems (“hands off the wheel”), the objective can be to provide an autonomous driving function for at least a certain time horizon (e.g., X seconds), such that if a condition arises that requires the driver's control, this condition will be predicted at least X seconds prior to its occurrence. The map data can further include camera and/or radar images of prominent landmarks (bridges, signs, roadside structures, etc.). In some implementations, BPM 134 of L3 systems may at any given time output two trajectories, Option A and a backup Option B, for X seconds. For example, when traveling on a city street in the rightmost lane of the street, BPM 134 can compute Option A for the vehicle to remain in the rightmost lane and can further compute Option B for the vehicle to move over to the left lane if a parked vehicle veers into the leftmost lane. BPM 134 can predict that within X seconds into the future the left lane is to remain available and continue vehicle operations. At some point, BPM 134 can predict that the left lane has a fast-moving agent that is to move close enough to the vehicle to make the left lane (and thus Option B) unavailable to the vehicle. Having determined that Option B is likely to become unavailable, BPM 134 can call the driver to take control of the vehicle. In yet even more sophisticated systems, where driver's input is not expected (e.g., autonomous L4 systems), if Option B disappears, AVCS 140 can stop the vehicle on the side of the road until the driving situation changes favorably.

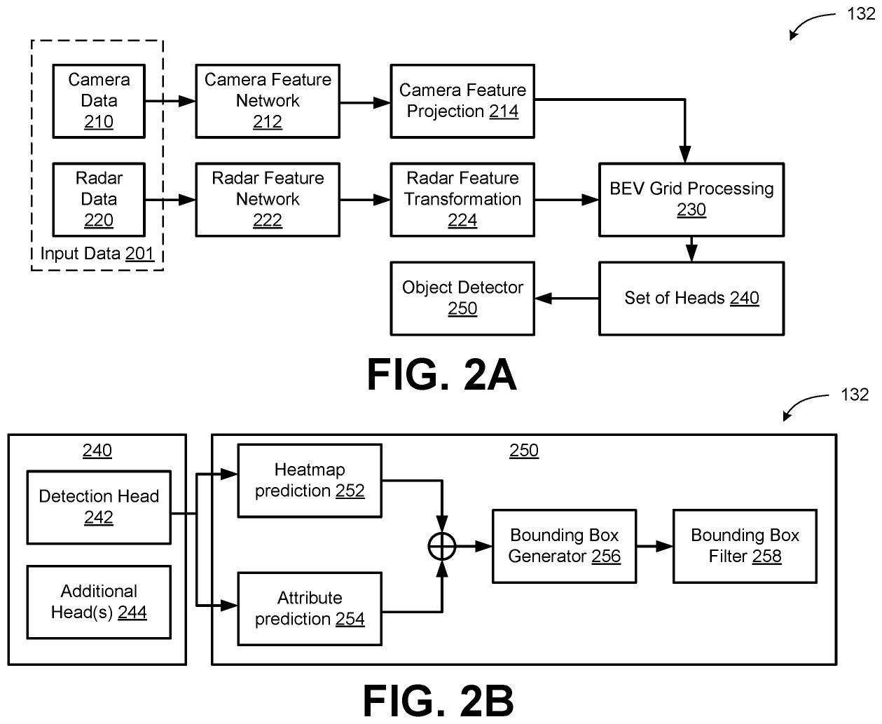

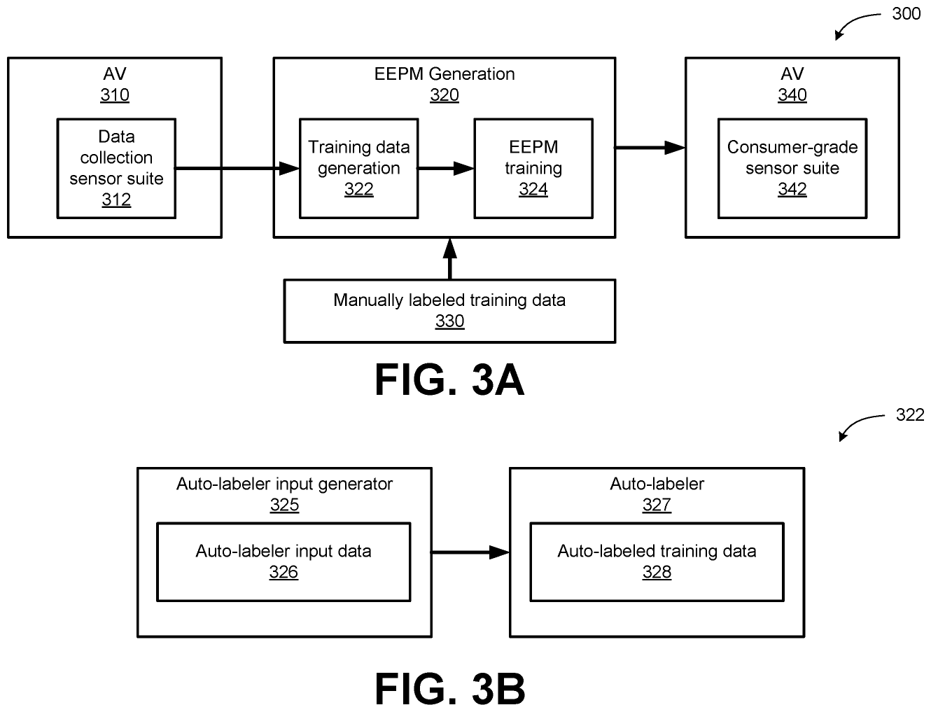

To achieve reliable predictions, BPM 134 can simulate multiple possible scenarios how different road users can behave in different ways and estimate the probability of various such scenarios and the corresponding outcomes. In some implementations, BPM 134 can use a closed-loop approach and determine a distribution of probabilities that, if the vehicle makes a certain driving path change (or maintains the current driving path), other vehicles are to respond in a certain way, e.g., to yield to the vehicle or to accelerate or otherwise block the vehicle's driving path. BPM 134 can evaluate multiple such scenarios and output probabilities for each or at least some of the scenarios. In some implementations, BPM 134 can use an open-loop approach, in which predictions are made based on the current state of motion of the agents and the changes of the motion of the vehicle do not affect the behavior of other agents. In some implementations, predicted locations of various agents can be represented via future occupancy heat maps. Further details regarding the EEPM 132 will now be described below with reference to FIGS. 2A-2B.

FIG. 2A is a diagram illustrating example network architecture of an end-to-end perception model (EEPM) 132 that can be deployed as part of a perception system of a vehicle, in accordance with some implementations of the present disclosure. Input data 201 can include data obtained by various components of the sensing system 110 (as depicted in FIG. 1), e.g., lidar(s) 112, radar(s) 114, optical (e.g., visible) range camera(s) 118, IR sensors(s) 119. For example, as shown, the input data 201 can include camera data 210 and radar data 220. Although not shown, the input data 201 can further include, e.g., lidar data.

The input data 201 can include images, radar and/or any other data, e.g., voxel intensity, velocity data associated with voxels, as well as metadata, such as timestamps. The input data 201 can include directional data (e.g., angular coordinates of return points), distance data, and radial velocity data, e.g., as can be obtained by lidar(s) 112 and/or radar(s) 114. Additionally, the input data 201 can further include roadgraph data stored by (or accessible to) perception system 130, e.g., as part of map information 124. Roadgraph data can include any two-dimensional maps of the roadway and its surrounding, three-dimensional maps (including any suitable mapping of stationary objects, e.g., identification of bounding boxes of such objects). It should be understood that this list of input data 201 is not exhaustive and any suitable additional data can be used as part of input data 201, e.g., IMU data, GNNS data, and the like. Each of the modalities of input data 201 can be associated with a specific instance of time when the data was acquired. A set of available data (e.g., a lidar image, a radar image, a camera image, and/or an IR camera image, etc.) associated with a specific instance of time can be referred to as a sensing frame. In some implementations, the images obtained by different sensors can be synchronized, so that all images in a given sensing frame have the same (up to an accuracy of synchronization) timestamp. In some implementations, some images in a given sensing frame can have (controlled) time offsets.

An image obtained by any of sensors can include a corresponding intensity map I({xⱼ}) where {xⱼ} can be any set of coordinates, including three-dimensional (spherical, cylindrical, Cartesian, etc.) coordinates (e.g., in the instances of lidar and/or radar images), or two-dimensional coordinates (in the instances of camera data). Coordinates of various objects (or surfaces of the objects) that reflect lidar and/or radar signals can be determined from directional data (e.g., polar θ and azimuthal ϕ angles in the direction of lidar/radar transmission) and distance data (e.g., radial distance R determined from the ToF of lidar/radar signals). The intensity map can identify intensity of sensing signals detected by the corresponding sensors. Similarly, lidar and/or radar sensors can produce Doppler (frequency shift) map, Δf({xⱼ} that identifies radial velocity of reflecting objects based on detected Doppler shift Δf of the frequency of the reflected radar signals, V=λΔf/2, where λ is the lidar/radar wavelength, with positive values Δf>0 associated with objects that move towards the lidar/radar (and, therefore, the vehicle) and negative values Δf<0 associated with objects that move away from the lidar/radar. In some implementations, e.g., in driving environments where objects are moving substantially within a specific plane (e.g., ground surface), the radar intensity map and the Doppler map can be defined using two-dimensional coordinates, such as the radial distance and azimuthal angle: I(R,ϕ),Δf(R,ϕ).

A camera feature network 212 can receive the camera data 210 and extract a set of camera data features from the camera data 210. For example, the set of camera data features can include a set of camera data feature vectors. More specifically, a camera data feature can be a two-dimensional (2D) camera data feature. Camera data feature network 212 can use any suitable perspective backbone(s) to obtain the set of camera data features. Examples of suitable perspective backbones include Resnet, EfficientNet, etc. In some implementations, each camera sensor (e.g., front-facing camera, rear-facing camera, etc.) can use the same vision backbone (e.g., same shared weights) in training to avoid learning viewpoint-specific priors to avoid performance of EEPM 132 to be affected by vehicle yaws. Each camera data feature can be associated with a particular pixel or a cluster of pixels. Each pixel (or a cluster of pixels) may be associated with a respective depth distribution and a respective depth feature. In some implementations, the processed camera data can be downsampled for computational efficiency. In some implementations, pseudo-cameras can be used. Pseudo-cameras represent crops of the images from the full resolution images to provide finer detail for long range tasks. The pseudo-cameras can have a fixed crop or a crop that is driven from an output of the coarse resolution backbone. In some implementations, the crops can be trained directly. In some implementations, differentiable cropping can be used to train the attention mechanism end-to-end.

Camera data features can be provided to a camera data feature projection component 214. The camera data feature projection component 214 can utilize camera data feature projection to transform the set of camera data features into a set of pixel points. For example, the set of pixel points can be a pixel point cloud. In some implementations, utilizing camera data feature projection includes performing a lift transformation with respect to 2D camera data (e.g., from 2D backbones, sensor intrinsics and extrinsics (or derived intrinsics and extrinsics for pseudo-cameras)). To do so, the camera data feature transformation component 214 can project the 2D camera data to a three-dimensional (3D) space. This projection can be done using various depth distribution techniques. During training, depth ground truth can be available from other sensor data (e.g., lidar data) and can be used as a structured loss. Output of other sensors that can provide 2D images (e.g., IR cameras) can be processed using the same (or similar) architecture. Accordingly, the camera data feature projection component 214 can provide a lifted camera “context” combined across the cameras of the AV.

More specifically, the lift transformation can combine depth distributions and the set of camera features (e.g., feature vectors). As an illustrative example, the lift transformation can supplement each pixel w,h, described by a feature vector FV(c)_{w,h} with depth information from depth distributions. For example, the lift transformation can compute an outer product of each feature vector FV(c)_{w,h} (of dimensions C×1) with the corresponding depth distribution P(d)_{w,h} (of dimensions D×1) for the same pixel. The output of the lift transformation can be a feature that can be represented by, e.g., FV(c)_{w,h}⊗P(d)_{w,h}=FT(c,d)_{w,h} for pixel w,h.

Feature tensors FT(c,d)_{w,h} computed for individual pixels can then be used to obtain a combined feature tensor for the whole image, e.g., by concatenating feature tensors for different pixels: {FT(c,d)_{w,h}}→CFT(c,d,w,h). The combined feature tensor CFT(c,d,w,h) has dimensions C×D×W×H. The combined feature tensor can then undergo a 2D mapping. More specifically, 2D mapping can produce a projected feature tensor that uses a convenient set of plane coordinates, e.g., Cartesian coordinates x and y or polar coordinates r and θ within the plane of the ground.

2D mapping can be a two-part transformation. During the first part, perspective coordinates d,w,h can be transformed into 3D Cartesian coordinates d,w,h=>x,y,z (or 3D cylindrical coordinates, w,h=→r,θ,z), with z being the vertical coordinate (in the direction perpendicular to the ground). The transformation d,w,h→x,y,z can be a projective transformation, parameterized with a focal length of the camera, direction of the optical axis of the camera, and other similar parameters. In the instances where images are acquired by multiple cameras (or a camera with a rotating optical axis), the transformation d,w,h→x,y,z can include multiple projective transformations, e.g., with a separate transformation used for pixels w,h provided by different cameras.

During the second part, 2D mapping can project the combined feature tensor expressed in the new coordinates, CFT(c,x,y,z), onto a horizontal surface to obtain a projected (BEV) feature tensor. For example, to obtain the C×W×H projected feature tensor PCT(c,x,y), the combined feature tensor can be summed (or averaged) over elements associated with each vertical pillar of pixels, e.g., PCT(c,x,y)=Σᵢ CFT (c, x,y,zᵢ). In some implementations, the summation over coordinates zᵢ can be performed with different weights wᵢ assigned to different coordinates zᵢ: PCT(c,x,y)=Σᵢ wᵢ×CFT(c,x,y,zᵢ), e.g., with larger weights wᵢ assigned to pixels that image objects within a certain elevations from the ground (e.g., up to several meters) and lower weights assigned to other elevations (e.g., to eliminate spurious objects, such as tree branches, electric cables, etc., that do not obstruct motion of vehicles). The projected feature tensor can characterize objects and their locations in the BEV in which perspective distortions have been reduced (e.g., eliminated).

A radar data feature network 222 can receive the radar data 220 and extract a set of radar data features from the radar data 220. For example, a radar data feature can be generated for each radar. Radar data feature network 222 can use any suitable radar backbone(s). Examples of suitable radar backbones include PointPillars, Range Sparse Net, etc. Each radar modality (e.g., intensity, second returns, Doppler shift, radar cross section) can have a different radar backbone and a feature generation layer. In some implementations, full periods (spins) of lidar/radar sensors can be used to obtain radar data features. In some implementations, portions of radar periods can be used to obtain radar data features. Processing of portions of such periods can allow EEPM 132 to react faster to new agents (e.g., vehicles, pedestrians, etc.) or sudden movements of existing agents in some cases and operate at the rate of the fastest sensor.

The set of radar data features can be provided to a radar data feature transformation component 224. The radar data feature transformation component 214 can utilize radar data feature transformation to transform the set of radar data features into a set of radar points. For example, the set of radar points can be a radar point cloud.

The set of pixel points generated by the camera data feature projection component 214 and the set of radar points generated by the radar data feature transformation component 224 can be provided to a BEV grid processing component 230. The BEV grid processing component 230 can combine the set of pixel points and the set of radar points to generate a set of BEV grids. It may be the case that the set of radar data features have a coordinate representation that is not computationally efficient for integration into a BEV grid. Thus, in some implementations, performing the radar data feature transformation can include transforming the coordinate representation of the set of radar data features to a suitable coordinate representation for integration into a BEV grid. For example, a computationally efficient representation can be a Cartesian coordinate representation. Illustratively, the radar data feature network 222 can process the radar data 220 in a polar coordinate representation, and transforming the coordinate representation includes transforming from the polar coordinate representation to the Cartesian coordinate representation.

Using the set of pixel points and the set of radar points to generate the set of BEV grids can include voxelizing the set of pixel points and the set of radar points to generate one or more BEV grids. In some implementations, the set of BEV grids includes a plurality of BEV grids.

In some implementations, the set of BEV grids defines a multi-scale BEV space, where each grid of the set of BEV grids is defined by a respective scale (e.g., resolution and/or size). The multi-scale BEV space is a shared feature space that can accumulate various available feature vector modalities. In some instances, a particular set of feature vectors (e.g., lidar features or roadgraph features) can be unavailable, temporarily or by design. In such instances, the respective contribution into multi-BEV space can be absent with EEPM 132 processing relying on other available features (e.g., camera and/or radar data features). The set of BEV grids defining the multi-BEV space can be recurrent, e.g., some proportion of the features obtained at time t₁ can be warped (using a differentiable warp such as a spatial transformer) and aggregated into new grids at time t₂ obtained together with the new features from time step t₂, e.g., using the smooth pose delta (i.e., pose change between time t₁ and time t₂). The multi-scale BEV space can be in a smooth pose consistent frame. The multi-scale BEV space can be spatially consistent for a period of time used for the aggregation in detection. In some implementations, a process for clearing distant portions of the grid and shifting values over as the AV moves through the world. Various priors in the global frame (e.g., elevation tiles, road graph) may undergo an accurate global-to-smooth transform. Dynamic objects may be represented using a flow field in combination with an occupancy map to perform additional recurrent aggregation. The multi-scale BEV space can be four-dimensional, with three spatial dimensions (e.g., 3D voxel space) and a time dimension. Each element of multi-scale BEV space can include a voxel, a time associated with this voxel, and a combined feature vector obtained by combining (e.g., concatenating) feature vectors output by various feature networks.

For example, the set of pixel points and the set of radar points can be voxelized to generate a first BEV grid defined by a first scale, and the set of pixel points and the set of radar points can be voxelized to generate a second BEV grid defined by a second scale different from the first scale. The first BEV grid can be a coarse BEV grid having a higher resolution (e.g., smaller voxel size) that can be used to detect objects closer to the AV, and the second BEV grid can be a fine BEV grid having a lower resolution (e.g., larger voxel size) for that can be used to detect objects further away from the AV. The sizes and/or resolutions of the BEV grids of the set of BEV grids can be dependent on the available computational facilities and specific driving missions, e.g., highway driving can involve grids with larger pixels (than in cases of urban driving) but extending to longer distances, proportional to the typical speeds involved. For example, even though fine BEV grids are more accurate than coarse BEV grids, coarse BEV grids can be used to reduce computational costs.

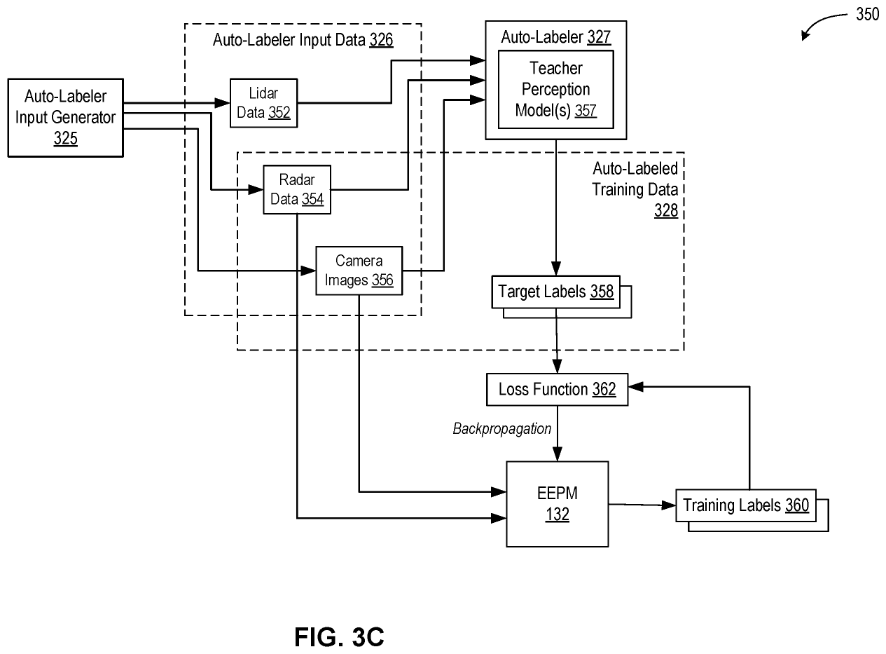

The BEV grid processing component 230 can further extract, for each BEV grid of the set of BEV grids, a respective set of BEV grid features. For example, the BEV grid processing component 230 can implement a set of BEV grid feature networks. Each BEV grid feature network of the set of BEV grid feature networks can extract, from a respective BEV grid of the set of BEV grids, the respective set of BEV grid features. Each BEV grid feature network can include any suitable number of layers for processing its respective BEV grid to extract the respective set of BEV grid features (e.g., layers implementing 3D convolutions in a ResNet-type architecture). For example, if the set of BEV grids includes the first BEV grid and the second BEV grid, then the set of BEV grid feature networks can include a first BEV grid feature network for extracting a first set of BEV grid features from the first BEV grid, and a second BEV grid feature network for extracting a second set of BEV grid features from the second BEV grid. The BEV grid processing component 230 can then resample each set of BEV grid features to its respective BEV grid to generate a resampled BEV grid. The BEV grid processing component 230 can then fuse each BEV grid together to generate a fused BEV grid. Further details regarding the set of BEV grids and the BEV grid processing component 230 will be described below with reference to FIG. 3.

The output of BEV grid processing component 230 (e.g., the fused BEV grid) can then be provided to a set of classifier heads (“heads”) 240. The set of heads 240 can include one or more heads that each generate a respective output. An output generated by at least one head of the set of heads 240 can be provided to an object detector 250. The object detector 250 can include one or more components to generate an object detection prediction based on the output(s) generated by the set of heads 240. If the set of BEV grids defines a multi-scale BEV space, then the scale of each BEV grid of the set of BEV grids can be handled in different ways, depending on a specific implementation. One approach can include cutting out, from the coarser scales, the voxel volume used by finer scales, so that one scale is used for various classification tasks. Such an approach can deploy special handling of voxels that are located in the vicinity of boundaries between different scales. Another option is to let each scale detect separately, then perform non-maximum suppression (NMS) over multiple scales. For example, one or more heads of the set of heads 240 can be allowed an access to multiple scales, when available. Yet another option can include enforcing sparsity in feature layers, implementing a threshold on a magnitude, and performing a sparse aggregation into a global voxel grid. Subsequent tasks can then use this sparse grid for inferences. Further details regarding the set of heads 240 and the object detector 250 will be described below with reference to FIG. 2B.

The EEPM 132 can include one or more additional feature networks (not shown). For example, the EEPM 132 can include a roadgraph feature network that can process roadgraph data and output roadgraph features that can include lanes and lane markings, road edges and medians, traffic lights and stop signs, crosswalks and speed bumps, driveways, parking lots and curb restrictions, railroad crossings, school zones, and zones inaccessible to traffic. Roadgraph features can be voxelized into coordinate frames. Roadgraph data can further include an elevation map. Such prior data can be treated as separate modalities. Such a framework can make it easier to incorporate new location-based data, such as a heatmap of object occurrences observed in previous runs. Roadgraph data can be accumulated during previous driving missions for a particular route. In some instances, where prior data is not available, roadgraph data can be limited by available map information 124 for a particular route. As with other modalities, roadgraph data can be missing, and during training EEPR 132 can be forced to learn to incorporate road graph data additively rather than rely on such data.

FIG. 2B illustrates an architecture of an EEPM 132 including the set of heads 240 and the object detector 250, in accordance with some implementations of the present disclosure. As shown, the set of heads 240 can include a detection head 242 and a set of additional heads 244.

The detection head 242 can be used to perform object detection. More specifically, the detection head 242 can classify boxes of voxels with emphasis on detecting objects. Examples of objects include agents (e.g., other vehicles), pedestrians, etc. In some implementations, the detection head 242 can further perform instance aggregation. Various approaches can be used that aggregate instances both over space and time such that a single detection or instance is a set of voxels xᵢ, yᵢ, zᵢ, tᵢ. In some implementations, a detection box approach can be used. More specifically, similar to the PointLens architecture, the detection head 242 can produce parameters for each box densely and then perform non-maximum suppression (NMS) or weighted aggregation to produce discrete detections. Each voxel can predict an existence probability, a center offset (dx,dy), a box extent (w,l), and a heading (which can be sin θ, cos θ). Although the detection box approach may not naturally allow the network to produce convex hulls, it is possible to use a Star-Poly type approach as an extension to accomplish this. In some implementations, the detection head 242 can further perform instance segmentation. In this approach, the network outputs dense per-instance occupancy. Such an approach can allow for convex hulls or even more general representations of object boundaries, which can be advantageous for articulated vehicles. For example, the segmentation approach can include the following operations: (i) produce a “centerness” output trained using a Gaussian that is close to the centroid of each object, (ii) produce an object center flow for each voxel within the object's bounds (dx,dy), (iii) find peaks in the centerness output using NMS, and (iv) associate voxels to each center using the center offset output masked using the occupancy map. Additional attributes can be aggregated using extra semantic heads and the voxel association. In some implementations, a signed distance field can be used. In this approach, the network can be trained to output a signed distance field representation. The network can then find zero crossings of this field plus containment to identify individual object instances (e.g., using a union-find algorithm). In some implementations, one or more of the described approaches can be combined.

Examples of heads of the set of additional heads 244 include a flow head, a segmentation head, an occupancy head, a semantics head, an occlusion head, a roadgraph head, etc. The flow head can output any suitable representation of flow (e.g., motion of objects) that corresponds to various voxels of space (e.g., using motion vectors or the like).

The occupancy head can determine whether voxels are occupied by an object. More specifically, the occupancy map gives a probability that a voxel location is inside an obstacle, e.g., similar to the probability-of-existence. The probability map can be used as a precursor data product to perform instance segmentation and other semantic inference tasks within the network.

The semantics head can be used to output the class of an object. For example, the semantics head can generate intent/semantics signals, including but not limited to such attributes as human poses, cyclist hand gestures, and the like. Various approaches to semantics tasks can be used depending on their quality bar. In one approach, a dense voxelized semantic layer can be deployed that uses the instance mask to look up and aggregate semantic signals. In another approach, a recurrent neural network can be deployed that uses instance location and extents to crop relevant features using region of interest (ROI) pooling from individual sensor backbones. This second approach can be advantageous for quality-critical tasks.

The occlusion head can output occlusion data related to an occluded object within the environment. For example, the occlusion data can include a probability that an occluded object exists at a location, a set of attributes of the occluded object (which can be conditioned on the occluded object being at the location), a probability that the occluded object would be perceived given the object's presence, etc. In some implementations, losses can be weighted using a probability-of-visibility mask to prevent the network to presciently guess properties about objects that the network should not be able to see.

The roadgraph head can output a reconstructed roadgraph in the vicinity of the vehicle based on a set of parameters. For example, the set of parameters can include voxel occupancy, flow of the motion of detected and classified objects, available map data, etc. The reconstructed roadgraph can be in a vectorized format (e.g., lanes represented as polylines) or a heat map format. In some implementations, the reconstructed roadgraph includes an association of various driving lanes to detected lights indicating whether the traffic is allowed to move in a particular lane. For example, a set of lights at an intersection can indicate that the rightmost lane has currently a green light that allows the right turn, two middle lines have red lights forbidding proceeding through the intersection in the forward direction, and the leftmost lane has a blinking yellow arrow indicating that the left turn is allowed provided that there is no oncoming traffic. The reconstructed roadgraph can be used to determine that the side of the street where the vehicle is located has four lanes and can further determine that the set of lights has four lights. The reconstructed roadgraph can include identification of the current statuses of each of the set of streetlights and the associations of each of the streetlights with the respective traffic lanes. Additionally, the reconstructed roadgraph can include the location of stop lines at the intersection.

Some of the heads of the set of heads 240 can be independent of additional heads of the set of heads 240, while some heads of the set of heads 240 can be interdependent of additional heads of the set of heads. For example, the detection head can be interdependent of at least the occupancy head, and the occupancy head can be interdependent of the semantics head.

In some implementations, the type of the object does not have to be determined and it can be sufficient to identify an occupancy grid (occupied and unoccupied voxels) and the flow (motion of the voxels) can be sufficient. For example, in highway driving use cases, identification of the type of an object can be less important than the fact that some object occupies a particular region of space (as all or most objects on the highways are vehicles). In urban driving use cases, identification of a type of an object can be more important as a much greater variety of road users can be present (e.g., pedestrians, electric scooters, bicyclists, dogs, etc.) each with a specific type of motion behavior (e.g., a pedestrian can be moving across a roadway).

As further shown, the object detector 250 can include a set of prediction components. Each prediction component of the set of prediction components can generate a respective prediction, forming a set of predictions. For example, the prediction components can include a heatmap prediction component 252 and an attribute prediction component 254. The heatmap prediction component 252 and the attribute prediction component 254 can each receive an output of at least the detection head 242 and generate heatmap prediction and an attribute prediction, respectively. Heatmap prediction values can represent the possibilities of an object appearing in the BEV grid. Examples of attribute predictions include object velocity predictions, vehicle lane association predictions (e.g., for telling which lane a vehicle is operating on), etc.

Each prediction of the set of predictions (e.g., the heatmap prediction and the attribute prediction) can be combined to obtain a combined prediction, and the combined prediction can be provided to a bounding box generator 256 to generate a set of candidate bounding boxes. Each candidate bounding box corresponds to a respective bounding box prediction for a corresponding object. More specifically, each candidate bounding box of the set of candidate bounding boxes describes a spatial location prediction of an object that is detected from the combined prediction. The set of candidate bounding boxes can include a single candidate bounding box for the object, or multiple overlapping candidate bounding boxes for the object.

The set of bounding box predictions can be provided to a bounding box filter 268 to select, as a bounding box for the object, an optimal candidate bounding box from the set of candidate bounding boxes. In some implementations, the bounding box filter 268 utilizes NMS. Accordingly, the object detector 250 can determine the most likely spatial location of an object based on a set of BEV grids generated from camera data and radar data.

FIG. 3A is a diagram illustrating an example system 300 that can be used to implement E2E trainable advanced driver-assistance systems, in accordance with some implementations of the present disclosure. As shown, the system 300 can include at least one AV 300 that can include a data collection sensor suite 312. For example, the data collection sensor suite 312 can include a combination of one or more camera(s), including IR cameras, one or more lidar(s), one or more radar(s), and/or other sensors (e.g., one or more sonars, one or more microphones, and/or the like). In some embodiments, the data collection sensor suite 312 includes at least a set of L4 system sensors. Additionally, the data collection sensor suite 312 can include a computing device with multiple processing devices, e.g., CPUs, GPUs, data processing units (DPUs), parallel processing units (PPUs), and/or the like, for computational power, and one or more memory devices communicatively coupled to the processing devices. The data collection sensor suite 312 can generate a first set of sensor data. For example, the first set of sensor data can include camera data, radar data, lidar data, audio data, etc.

The system 300 can further include an EEPM generation system 320. EEPM generation system 320 can be used to generate (e.g., train and/or update) an EEPM, such as EEPM 132 of FIG. 1. For example, the EEPM generation system 320 can include a training data generation component 320 to generate training data for training an EEPM, and an EEPM training component 324 to train and/or retrain an EEPM. The training data generation component 322 can be trained to generate a set of auto-labeled training data that can be used by the EEPM training component 324 to train or retrain an EEPM. For example, the training data generation component 322 can be trained to generate a set of auto-labeled training data using data obtained from the data collection sensor suite 312. The EEPM can be trained using at least the set of auto-labeled training data generated by the training data generation component 322. Additionally or alternatively, the training data generation component 322 can be trained to generate auto-labeled training data using manually labeled training data 330. Additionally or alternatively, the EEPM training component 324 can use the manually labeled training data 330 to train or retrain the EEPM. In some embodiments, the manually labeled training data 330 includes manually annotated training data.

In some embodiments, generating a set of auto-labeled training data using the first set of sensor data includes fusing sensor data of the first set of sensor data (e.g., lidar, radar, camera and audio). Sensor data fusion can be used to combine strengths of each type of sensing modality of the data collection sensor suite 312. In some embodiments, generating a set of auto-labeled training data includes performing automated pre-mapping of a region (e.g., using the manually labeled training data 330). For example, automated pre-mapping of a region can be used to associate a set of known lanes with a traffic light. In some embodiments, generating a set of auto-labeled training data using the first set of sensor data includes performing bidirectional sequence modeling. For example, bidirectional sequence modeling can include looking forward and/or backward over sequences of time to improve accuracy and understanding of a scene associated with a driving environment. In some embodiments, generating the set of auto-labeled training data includes processing log data corresponding to the data collection sensor suite 312 in an offline setting. In some embodiments, generating the set of auto-labeled training data includes processing sensor data online while the AV 310 is operating. Further details regarding the training data generation component 322 will now be below with reference to FIG. 3B.

As further shown in FIG. 3A, the system 300 can further include an AV 340. For example, the AV 340 can be similar to the AV 100 of FIG. 1. In some embodiments, at least one of the training data generation component 322 or the EEPM training component 324 is implemented within the AV 310. In some embodiments, at least one of the training data generation component 322 or the EEPM training component 324 is implemented within the AV 340. In some embodiments, EEPM generation system 320 is a central computing device (e.g., server) communicably coupled to the AV 310 and the AV 100 over a network (e.g., cloud server).

The AV 340 can include a consumer-grade sensor suite 342. For example, the consumer-grade sensor suite 342 can be included within the sensing system 110 of FIG. 1. The consumer-grade sensor suite 342 can be a less sophisticated sensor suite as compared to the data collection sensor suite 312. For example, the sensors of the consumer-grade sensor suite 342 can be of lower quality or fidelity than the sensors of the data collection sensor suite 312. That is, a second set of sensor data generated by one or more sensors of the consumer-grade sensor suite 342 can be of lower quality than the first set of sensor data generated by the data collection sensor suite 312. Additionally or alternatively, the consumer-grade sensor suite 342 can include fewer sensors than the data collection sensor suite 312. In some embodiments, the consumer-grade sensor suite 342 includes a combination of camera(s) and radar(s). For example, the consumer-grade sensor suite 342 can have lower fidelity cameras and/or radars as compared to the cameras and/or radars of the data collection sensor suite 312. Additionally or alternatively, the consumer-grade sensor suite 342 can include fewer cameras and/or radars than the data collection sensor suite 312. Additionally or alternatively, the consumer-grade sensor suite 342 can include fewer types of sensors than the data collection sensor suite 312. In some embodiments, the consumer-grade sensor suite 342 includes a set of L2 system sensors and the data collection sensor suite 312 includes a set of at least LA system sensors.

The auto-labeled training data generated by the training data generation component 322 based on the first set of data generated by the data collection sensor suite 312 can compensate for the lower quality or fidelity of a second set of data generated by the consumer-grade sensor suite 342. Accordingly, the training of an EEPM by EEPM training component 324 to perform AV tasks (e.g., object detection) using consumer-grade sensor suite 342 can be enhanced by generating auto-labeled training data that leverages higher quality or fidelity sensor data obtained from the data collection sensor suite 312. Further details regarding the training data generation component 322 will now be described below with reference to FIG. 3B.

Referring now to FIG. 3B, the training data generation component 322 can include an auto-labeler input generator 325 to generate a set of auto-labeler input data 326. In some embodiments, the auto-labeler input generator 325 is included in the AV 310 described above with reference to FIG. 3A. In some embodiments, the auto-labeler input generator 325 is included in the AV 340 described above with reference to FIG. 3A. For example, the auto-labeler input generator 325 can be included within a perception system that has access to high-quality high-definition (HD) maps and compute resources (e.g., GPU compute resources).

As further shown, the training data generation component 322 can include an auto-labeler 327. The auto-labeler 327 can receive the auto-labeler input data 326, and automatically generate a set of auto-labeled training data 328 based at least in part on the auto-labeler input data 326. For example, generating the set of auto-labeled training data 328 can include automatically generating a set of labels used for training a machine learning model (e.g., an EEPM).

One example of an auto-label of the set of auto-labeled training data 328 is a precise location (e.g., three-dimensional (3D)) location of an objected detected within a scene. Another example of an auto-label of the set of auto-labeled training data 328 is a tracking of the object. Another example of an auto-label of the set of auto-labeled training data 328 is an enriched semantic understanding of an object. Examples of enriched semantic understandings of objects include vehicle tail light indicators, emergency vehicle siren and emergency light states, fine grained classification of pedestrians such as use of scooters or other acceleration devices, hand signals from pedestrians such as pointing or holding signs, etc. Yet another example of an auto-label of the set of auto-labeled training data 328 is a road feature such as a lane and/or a line of a road. Yet another example of an auto-label of the set of auto-labeled training data 328 an association of an object to a road feature, such as a traffic light or a sign to a corresponding lane of a road.

In some embodiments, the training data generation component 322 implements a set of specially trained machine learning models (e.g., neural network models). Each machine learning model of the set of specially trained machine learning models can be trained to perform a respective task that can be used to generate the set of auto-labeled training data 328. For example, at least one machine learning model of the set of specially trained machine learning models can be trained to detect objects. Examples of objects include people, vehicles, traffic lights, signs, cones, etc. As another example, at least one machine learning model of the set of specially trained machine learning models can be trained to track objects. As yet another example, at least one machine learning model of the set of specially trained machine learning models can be trained to semantically enrich objects. For example, the set of specially trained machine learning models can include a traffic light state model, a human gesture recognition model, etc.

In some embodiments, training an EEPM (e.g., EEPM 132 of FIG. 1) includes performing a multi-stage training process. For example, the multi-stage training process can include a pre-training stage in which a base model is trained using the set of auto-labeled training data 328, and a fine-tuning stage in which the base model is further trained to obtain a trained EEPM. More specifically, the pre-training stage can be used to perform task-agnostic training of the EEPM for general object detection applicable with respect to a set of object detection tasks, and the fine-tuning stage can be used to perform task-specific training of the EEPM for a particular object detection task of the set of object detection tasks. For example, task-specific training of the EEPM can be performed using a set of manually labeled training data (e.g., the set of manually labeled training data 340 of FIG. 3A). For example, the set of manually labeled training data can be used during the training process to introduce information that was not included within the set of auto-labeled training data 328. Accordingly, the training of the EEPM using the set of auto-labeled training data 328 can be supplemented with a set of manually labeled training data, if needed for task-specific training.

Automatically generating labels using the training data generation component 322 can reduce or eliminate the use of manual labeling (e.g., annotation), which can increase computational efficiency and reduce computation resource consumption. Additionally, automatically generating labels using the training data generation component 322 can enable modification in compute resources (e.g., increase or decrease) in a uniform way by tuning the size of the EEPM (e.g., tuning the size of the neural network architecture of the EEPM).

FIG. 3C illustrates example operations 350 that can be used for training E2E advanced driver-assistance systems, in accordance with some implementations of the present disclosure. As illustrated, auto-labeler input generator 325 can generate or collect sensing data-auto-labeler input data 326—that can be obtained during driving missions of AV 100. In some implementations, auto-labeler input data 326 can be collected by a street view car, which can be a car driven by a human driver. In some implementations, some of auto-labeler input data 326 can be synthetic data. Auto-labeler input data 326 can have multiple sensing modalities, e.g, lidar data 352, radar data 354, camera images 356, and/or various other sensing data (e.g., audio data). In some implementations, lidar data 352, radar data 354, camera images 356, and/or other sensing data can capture substantially the same portions of driving environments and can additionally be synchronized, such that data of different modalities refers to the same portions of the driving environment at the same (or substantially the same) times.

Auto-labeler 327 can include one or more teacher perception models 357 trained to process the sensing data and identify target labels 358. Target labels 358 can include any classifications and/or determinations made by teacher perception model(s) 357 about objects captured by auto-labeler input data 326 for the corresponding driving environments, such as locations of the objects (e.g., bounding boxes, polygons, convex hulls, etc.), state of motion of the objects (e.g., speed of motion), types of the objects (e.g., car, truck, bus, motorcycle, bicycle, pedestrian, animal, etc.), tracks of the objects (e.g., locations, speed, directions of motion of the objects over a certain historical period, e.g., several seconds), and/or the like. Teacher perception model(s) 357 can be trained using any suitable techniques, including supervised training, unsupervised training, reinforcement learning, and/or the like. Teacher perception model(s) 357 can be trained using training sensing data of the same (or similar) modalities as used in inference, e.g., camera/lidar/radar/audio/etc. sensing data. The training data used to train teacher perception model(s) 357 can be manually annotated by an engineer and/or developer. Teacher perception model(s) 357 need not be an E2E model (or multiple E2E models) and can include any number of models operating in concern or independently. Any of the teacher perception model(s) 357 can be trained together or separately. Any, some, or all of the target labels 358 can be generated by the same teacher perception model or separate teacher perception models. For example, one of teacher perception models 357 can identify a bounding box for an object and another teacher perception model 357 can identify a type of the object.

Target labels 358 can be generated by teacher perception model(s) 357 operating in the inference mode, e.g., after the models have been trained. Accordingly, inference operations of teacher perception model(s) 357 need not be supervised and target labels 358 can be used as part of auto-labeled training data 328. Additionally, auto-labeled training data 328 can include training inputs to be used in training of EEPM 132, e.g., training inputs of the camera and the radar modalities. In some implementations, the training data included in auto-labeled training data 328 can include camera images 356 and radar data 354 used as part of the same auto-labeler input data 326 processed by teacher perception model(s) 357 to generate target labels 358.

Target labels 358 can be used as ground truth for training of EEPM 132. More specifically, EEPM 132 can process inputs (e.g., camera images 356 and radar data 354) and generate training labels 360, which can be of the same kind as target labels 358. A suitable loss function 362 function can be used to compare and evaluate (quantify) differences between training labels 360 and target labels 358. Loss function 362 can include one or more of a mean squared error loss function (e.g., to evaluate departure from continuous ground truth values, e.g., locations, velocities, sizes of bounding boxes, and/or the like), cross-entropy loss function (e.g., to evaluate departures from discrete classifications), and/or any other suitable loss function, e.g., mean absolute error loss function, hinge loss function, and/or the like. The difference between training labels 360 and target labels 358 can be backpropagated through various trainable parameters of EEPM 132, e.g., using the steepest descent techniques and/or similar training algorithms with parameters of EEPM 132 modified to bring training labels 360 closer to target labels 358, e.g., until a desired accuracy of EEPM 132 classifications is achieved. The trained EEPM 132 can be subsequently downloaded onto the perception and planning system of a suitable vehicle, e.g., AV 100, a fully autonomous vehicle, a vehicle deploying a driving assist system, and/or some other vehicle.

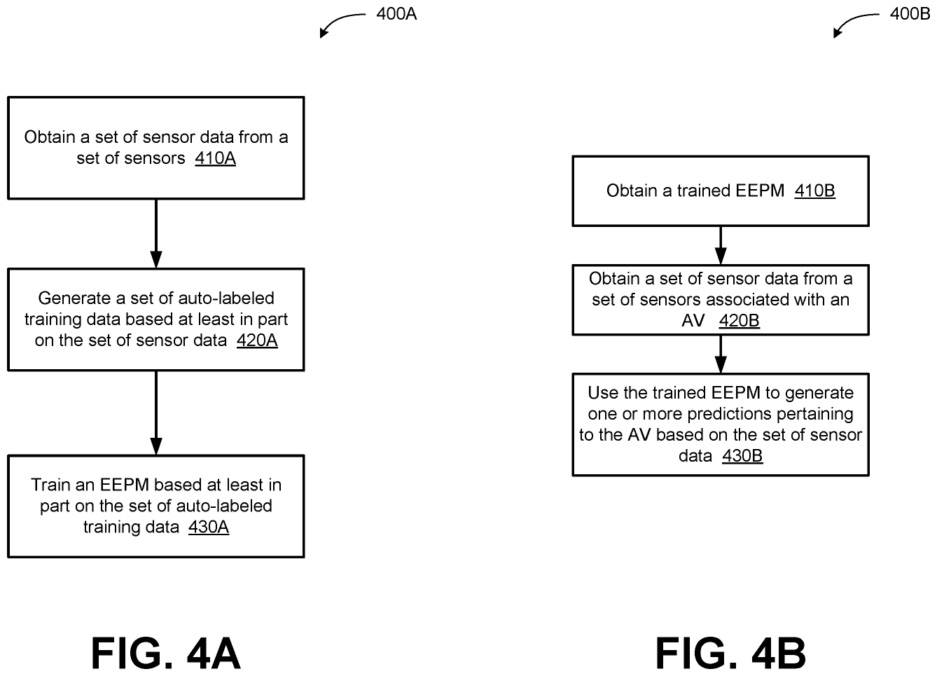

FIG. 4A is a flow diagram illustrating an example method 400A of implementing E2E trainable advanced driver-assistance systems, in accordance with some implementations of the present disclosure. At least one processing device operatively coupled to memory can perform method 400A and/or each of their individual functions, routines, subroutines, or operations. For example, one or more processors can be communicably coupled to one or more memory devices. Examples of processors include central processing units (CPUs), graphics processing units (GPUs), tensor processing units (TPUs), application-specific integrated circuits (ASICs), field-programmable gate arrays (FPGAs), etc. A processing device executing method 400A can perform instructions issued by various components of an EEPM generation system (e.g., EEPM generation system 320 of FIG. 3A) to train an EEPM (e.g., EEPM 132), or any other similar model, which may be a part of a perception system of an AV (e.g., perception system 130 of FIG. 1), a vehicle that deploys driver assistance technology, or a part of any other application platform that uses object detection and classification. For example, method 400A can be used to improve performance of a data processing system and/or an AVCS (e.g., the data processing system 120 and/or the AVCS 140 of FIG. 1).

In some implementations, a single processing thread can perform method 400A. Alternatively, two or more processing threads can perform method 400A, with each thread executing one or more individual functions, routines, subroutines, or operations of method 400A. In an illustrative example, the processing threads implementing method 400A can be synchronized (e.g., using semaphores, critical sections, and/or other thread synchronization mechanisms). Alternatively, the processing threads implementing method 400A can be executed asynchronously with respect to each other. Various operations of method 400A can be performed in a different order compared with the order shown in FIG. 4A. Some operations of method 400A can be performed concurrently with other operations. Some operations can be optional.

At operation 410A, processing logic obtains a set of sensor data from a set of sensors. The set of sensors can be associated with an AV. For example, the set of sensors can be mounted on the AV. The AV can be a data collection AV included within a fleet of AVs used for data collection. The set of sensor data can be obtained within a driving environment of the AV. The set of sensors can correspond to a data collection sensor suite, such as the data collection sensor suite 312 of FIG. 3A. For example, the sensor data can include at least one of: camera data derived from at least one camera, radar data derived from at least one radar, lidar data derived from at least one lidar, audio data derived from at least one microphone, etc. In some embodiments, the set of sensors includes at least a set of LA system sensors. Additionally, the set of sensors can include a computing device with multiple GPUs for computational power.

At operation 420A, processing logic generates a set of auto-labeled training data based at least in part on the set of sensor data. For example, generating the set of auto-labeled training data can include generating a set of auto-labeler input data based on the set of sensor data, and generating the set of auto-labeled training data based at least in part on the set of auto-labeler input data. In some embodiments, the auto-labeling input data is further generated from a set of manually labeled training data.

At operation 430A, processing logic trains an EEPM based at least in part on the auto-labeled training data. For example, the EEPM can be implemented by a second AV (e.g., the perception system of the second AV) to perform at least one task related to operating the second AV within a driving environment. Examples of tasks include object detection, object tracking, etc. The EEPM can be trained to perform the at least one task based on a second set of sensor data generated by a second set of sensors associated with the second AV (e.g., mounted on the second AV). More specifically, the second set of sensors can correspond to a consumer-grade sensor suite that is less sophisticated as compared to the data collection sensor suite, as described above with reference to FIGS. 3A-3B. For example, the second AV can include camera(s) and radar(s). In some embodiments, the second set of sensors includes a set of L2 system sensors.

In some embodiments, training the EEPM includes performing a multi-stage training process. For example, the multi-stage training process can include a pre-training stage in which a base model is trained using the set of auto-labeled training data, and a fine-tuning stage in which the base model is further trained to obtain a trained EEPM. More specifically, the pre-training stage can be used to perform task-agnostic training of the EEPM for general object detection applicable with respect to a set of object detection tasks, and the fine-tuning stage can be used to perform task-specific training of the EEPM for a particular object detection task of the set of object detection tasks. For example, task-specific training of the EEPM can be performed using a set of manually labeled training data (e.g., human-annotated training data). The set of manually labeled training data can introduce information that was not included within the auto-labeled training data. Accordingly, the training of the EEPM using the set of auto-labeled training data can be supplemented with the set of manually labeled training data, if needed for task-specific training. Further details regarding operations 410A-430A are described above with reference to FIGS. 1-3B.

FIG. 4B is a flow diagram illustrating an example method 400B of implementing E2E trainable advanced driver-assistance systems, in accordance with some implementations of the present disclosure. At least one processing device operatively coupled to memory can perform method 400B and/or each of their individual functions, routines, subroutines, or operations. For example, one or more processors can be communicably coupled to one or more memory devices. Examples of processors include central processing units (CPUs), graphics processing units (GPUs), tensor processing units (TPUs), application-specific integrated circuits (ASICs), field-programmable gate arrays (FPGAs), etc. A processing device executing method 400B can perform instructions issued by various components of the sensing system 110 or data processing system 120 of FIG. 1. In some implementations, method 400B can be directed to systems and components of an AV, such as AV 100 of FIG. 1 and/or AV 340 of FIG. 3A. In some implementations, at least a portion of method 400B can be performed using an EEPM (e.g., EEPM 132), or any other similar model, which may be a part of a perception system of the AV (e.g., perception system 130 of FIG. 1), a vehicle that deploys driver assistance technology, or a part of any other application platform that uses object detection and classification. For example, method 400B can be used to improve performance of a data processing system and/or an AVCS (e.g., the data processing system 120 and/or the AVCS 140 of FIG. 1).

In some implementations, a single processing thread can perform method 400B. Alternatively, two or more processing threads can perform method 400B, with each thread executing one or more individual functions, routines, subroutines, or operations of method 400B. In an illustrative example, the processing threads implementing method 400B can be synchronized (e.g., using semaphores, critical sections, and/or other thread synchronization mechanisms). Alternatively, the processing threads implementing method 400B can be executed asynchronously with respect to each other. Various operations of method 400B can be performed in a different order compared with the order shown in FIG. 4B. Some operations of method 400B can be performed concurrently with other operations. Some operations can be optional.

At operation 410B, processing logic obtains a trained EEPM. More specifically, the trained EEPM can be trained to generate one or more predictions pertaining to an AV. In some embodiments, the one or more predictions include an object detection prediction. In some embodiments, the one or more predictions include an object tracking prediction. For example, the EEPM can be trained based on auto-labeled training data generated from a set of sensor data obtained from a data collection sensor suite, as described above with reference to FIGS. 3A-4A. In some embodiments, the data collection sensor suite corresponds to a set of LA system sensors.

In some embodiments, obtaining the trained EEPM includes training an EEPM. In some embodiments, obtaining the trained EEPM includes training a general EEPM. In some embodiments, the general EEPM is further trained to obtain a task specific EEPM trained to perform a specific AV task. For example, the general EEPM can be further trained using a set of manually labeled training data, an additional set of auto-labeled training data, etc.

At operation 420B, processing logic obtains a set of sensor data from a set of sensors associated with an AV. More specifically, the set of sensors can be mounted on the AV. The set of sensors can correspond to a consumer-grade sensor suite less sophisticated than the data collection sensor suite, as described above with reference to FIGS. 3A-4A. For example, the set of sensors can include camera(s) and radar(s) and the set of sensor data can include camera data and radar data. In some embodiments, the set of sensors corresponds to a set of L2 system sensors.

At operation 430B, processing logic uses the trained EEPM to generate one or more predictions based on the set of sensor data. More specifically, the set of sensor data can be provided as input into the trained EEPM, and the trained EEPM can generate the one or more predictions based on the set of sensor data. In some embodiments, the one or more predictions include an object detection prediction. In some embodiments, the one or more predictions include an object tracking prediction. Further details regarding operations 410B-430B are described above with reference to FIGS. 1-4A.

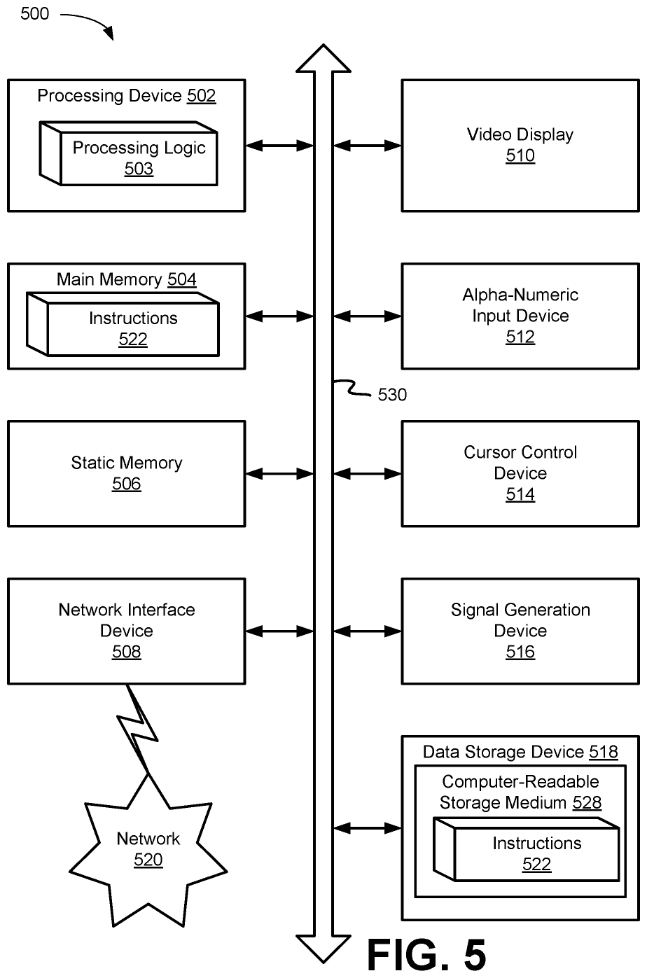

FIG. 5 depicts a block diagram of an example computing device 500, in accordance with some implementations of the present disclosure. Example computing device 500 can be connected to other computing devices in a LAN, an intranet, an extranet, and/or the Internet. Computing device 500 can operate in the capacity of a server in a client-server network environment. Computing device 500 can be a personal computer (PC), a set-top box (STB), a server, a network router, switch or bridge, or any device capable of executing a set of instructions (sequential or otherwise) that specify actions to be taken by that device. Further, while only a single example computing device is illustrated, the term “computer” shall also be taken to include any collection of computers that individually or jointly execute a set (or multiple sets) of instructions to perform any one or more of the methods discussed herein.

Example computing device 500 can include a processing device 502 (also referred to as a processor or CPU), a main memory 504 (e.g., read-only memory (ROM), flash memory, dynamic random access memory (DRAM) such as synchronous DRAM (SDRAM), etc.), a static memory 506 (e.g., flash memory, static random access memory (SRAM), etc.), and a secondary memory (e.g., a data storage device 518), which can communicate with each other via a bus 530.

Processing device 502 (which can include processing logic 503) represents one or more general-purpose processing devices such as a microprocessor, central processing unit, or the like. More particularly, processing device 502 can be a complex instruction set computing (CISC) microprocessor, reduced instruction set computing (RISC) microprocessor, very long instruction word (VLIW) microprocessor, processor implementing other instruction sets, or processors implementing a combination of instruction sets. Processing device 502 can also be one or more special-purpose processing devices such as an application specific integrated circuit (ASIC), a field programmable gate array (FPGA), a digital signal processor (DSP), network processor, or the like. In accordance with one or more aspects of the present disclosure, processing device 502 can be configured to execute instructions performing method 400A of FIG. 4.

Example computing device 500 can further comprise a network interface device 508, which can be communicatively coupled to a network 520. Example computing device 500 can further comprise a video display 510 (e.g., a liquid crystal display (LCD), a touch screen, or a cathode ray tube (CRT)), an alphanumeric input device 512 (e.g., a keyboard), a cursor control device 514 (e.g., a mouse), and an acoustic signal generation device 516 (e.g., a speaker).

Data storage device 518 can include a computer-readable storage medium (or, more specifically, a non-transitory computer-readable storage medium) 528 on which is stored one or more sets of executable instructions 522. In accordance with one or more aspects of the present disclosure, executable instructions 522 can comprise executable instructions performing method 400A of FIG. 4.

Executable instructions 522 can also reside, completely or at least partially, within main memory 504 and/or within processing device 502 during execution thereof by example computing device 500, main memory 504 and processing device 502 also constituting computer-readable storage media. Executable instructions 522 can further be transmitted or received over a network via network interface device 508.

While the computer-readable storage medium 528 is shown in FIG. 5 as a single medium, the term “computer-readable storage medium” should be taken to include a single medium or multiple media (e.g., a centralized or distributed database, and/or associated caches and servers) that store the one or more sets of operating instructions. The term “computer-readable storage medium” shall also be taken to include any medium that is capable of storing or encoding a set of instructions for execution by the machine that cause the machine to perform any one or more of the methods described herein. The term “computer-readable storage medium” shall accordingly be taken to include, but not be limited to, solid-state memories, and optical and magnetic media.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “obtaining,” “generating,” “providing,” “causing,” “transforming,” “fusing,” “selecting,” “performing,” “training,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Examples of the present disclosure also relate to an apparatus for performing the methods described herein. This apparatus can be specially constructed for the required purposes, or it can be a general purpose computer system selectively programmed by a computer program stored in the computer system. Such a computer program can be stored in a computer readable storage medium, such as, but not limited to, any type of disk including optical disks, CD-ROMs, and magnetic-optical disks, read-only memories (ROMs), random access memories (RAMs), EPROMs, EEPROMs, magnetic disk storage media, optical storage media, flash memory devices, other type of machine-accessible storage media, or any type of media suitable for storing electronic instructions, each coupled to a computer system bus.

The methods and displays presented herein are not inherently related to any particular computer or other apparatus. Various general purpose systems can be used with programs in accordance with the teachings herein, or it may prove convenient to construct a more specialized apparatus to perform the required method steps. The required structure for a variety of these systems will appear as set forth in the description below. In addition, the scope of the present disclosure is not limited to any particular programming language. It will be appreciated that a variety of programming languages can be used to implement the teachings of the present disclosure.

It is to be understood that the above description is intended to be illustrative, and not restrictive. Many other implementation examples will be apparent to those of skill in the art upon reading and understanding the above description. Although the present disclosure describes specific examples, it will be recognized that the systems and methods of the present disclosure are not limited to the examples described herein, but can be practiced with modifications within the scope of the appended claims. Accordingly, the specification and drawings are to be regarded in an illustrative sense rather than a restrictive sense. The scope of the present disclosure should, therefore, be determined with reference to the appended claims, along with the full scope of equivalents to which such claims are entitled.

What is claimed is:

1. A method comprising:
generating a set of auto-labeled training data using a first autonomous vehicle (AV) system having multiple sensor modalities, wherein the auto-labeled training data comprises:
a first set of non-lidar data associated with the first AV system, and
one or more target predictions for the first set of non-lidar data, said predictions generated based at least on lidar data associated with the first AV system; and
training, by the processing device and using the auto-labeled training data, an end-to-end perception model of a second AV system lacking a lidar sensor to predict presence of one or more objects in a driving environment of the second AV system.

2. The method of claim 1, further comprising:
obtaining a second set of sensor data using the second AV system, wherein the second set of sensor data:
comprises sensor data of the second plurality of sensor modalities, and
characterizes one or more objects in a driving environment of the second vehicle; and
processing, using the trained end-to-end perception model, the second set of sensor data to obtain one or more inference predictions associated with the one or more objects in the driving environment of the second AV system.

3. The method of claim 2, wherein the second set of sensors of the second vehicle comprises at least one camera sensor or at least one radar sensor.

4. The method of claim 1, wherein the one or more target predictions are generated by one or more models trained using a set of manually-labeled training data.

5. The method of claim 1, wherein training the end-to-end perception model of the second AV system comprises:
pre-training a base model using the set of auto-labeled training data; and
fine-tuning the pre-trained base model using at least one set of manually labeled training data.

6. The method of claim 1, wherein the one or more target predictions comprise at least one of:
a bounding box for an object represented in the first set of sensor data,
a type of the object detection represented in the first set of sensor data, or
a motion track of the object detection represented in the first set of sensor data.

7. The method of claim 1, wherein the second set of sensor data comprises at least some of the sensor data of the first set of sensor data.

8. The method of claim 1, wherein the one or more target predictions are further based on:
camera data associated with the first AV system, and
radar data associated with the first AV system.

9. A system comprising:
a memory; and
a processing device communicative coupled to the memory, the processing device configured to:
generate a set of auto-labeled training data using a first autonomous vehicle (AV) system having multiple sensor modalities, wherein the auto-labeled training data comprises:
a first set of non-lidar data associated with the first AV system, and
one or more target predictions for the first set of non-lidar data, said predictions generated based at least on lidar data associated with the first AV system; and
train, using the auto-labeled training data, an end-to-end perception model of a second AV system lacking a lidar sensor to predict presence of one or more objects in a driving environment of the second AV system.

10. The system of claim 9, wherein the processing device is further configured to:
obtain a second set of sensor data using the second AV system, wherein the second set of sensor data:
comprises sensor data of the second plurality of sensor modalities, and
characterizes one or more objects in a driving environment of the second vehicle; and
process, using the trained end-to-end perception model, the second set of sensor data to obtain one or more inference predictions associated with the one or more objects in the driving environment of the second AV system.

11. The system of claim 10, wherein the second set of sensors of the second vehicle comprises at least one camera sensor or at least one radar sensor.

12. The system of claim 9, wherein the one or more target predictions are generated by one or more models trained using a set of manually-labeled training data.

13. The system of claim 9, wherein to train the end-to-end perception model of the second AV system, the processing device is further configured to:
pre-train a base model using the set of auto-labeled training data; and
fine-tune the pre-trained base model using at least one set of manually labeled training data.

14. The system of claim 9, wherein the one or more target predictions comprise at least one of:
a bounding box for an object represented in the first set of sensor data,
a type of the object detection represented in the first set of sensor data, or
a motion track of the object detection represented in the first set of sensor data.

15. The system of claim 9, wherein the second set of sensor data comprises at least some of the sensor data of the first set of sensor data.

16. The system of claim 9, wherein the one or more target predictions are further based on:
camera data associated with the first AV system, and
radar data associated with the first AV systems.

17. A non-transitory computer-readable storage medium having instructions stored thereon that, when executed by a processing device, cause the processing device to perform operations comprising:
generating a set of auto-labeled training data using a first autonomous vehicle (AV) system having multiple sensor modalities, wherein the auto-labeled training data comprises:
a first set of non-lidar data associated with the first AV system, and
one or more target predictions for the first set of non-lidar data, said predictions generated based at least on lidar data associated with the first AV system; and
training, using the auto-labeled training data, an end-to-end perception model of a second AV system lacking a lidar sensor to predict presence of one or more objects in a driving environment of the second AV system.

18. The non-transitory computer-readable storage medium of claim 17, wherein the operations further comprise:
obtaining a second set of sensor data using the second AV system, wherein the second set of sensor data:
comprises sensor data of the second plurality of sensor modalities, and
characterizes one or more objects in a driving environment of the second vehicle; and
processing, using the trained end-to-end perception model, the second set of sensor data to obtain one or more inference predictions associated with the one or more objects in the driving environment of the second AV system.

19. The non-transitory computer-readable storage medium of claim 17, wherein the second set of sensors of the second vehicle comprises at least one camera sensor or at least one radar sensor.

20. The non-transitory computer-readable storage medium of claim 17, wherein the one or more target predictions comprise at least one of:
a bounding box for an object represented in the first set of sensor data,
a type of the object detection represented in the first set of sensor data, or
a motion track of the object detection represented in the first set of sensor data.
